(19) United States
(12) Patent Application Publication
(10) Pub. No.: US 2001/0035174 A1
(43) Pub. Date: Nov. 1, 2001

(54) Stone cutter

(76) Inventors: Roy G. O'Neal, Mobile, AL (US); Frank Treadaway, Mobile, AL (US); Ronald E. Swafford, Anniston, AL (US)

Correspondence Address: GREGORY M. FRIEDLANDER & ASSOCIATES, P.C., 11 SOUTH FLORIDA STREET, MOBILE, AL, 36606-1934, US

(21) Appl. No.: 09/849,095

(22) Filed: May 4, 2001

Related U.S. Application Data
(60) Provisional application No. 60/202,498, filed on May 5, 2000.

(51) Int. Cl. B28D 1/32

(52) U.S. Cl. 125/23.01

(57) ABSTRACT

A rock cutter for splitting stones is disclosed which shows a support surface for holding the rock and (a) a first blade and (b) a second blade which may be position to hold the rock between the first and second blades and on the support surface along with a means for moving the first blade towards the second blade. The means for moving comprises a hydraulicly driven piston having a piston arm to which the first blade is mounted. The invention also includes shock means for applying a sudden force to the first blade. The rock cutter also has a cover which is used in conjunction with a means for receiving pieces at an angle after the split.

PRIORITY

This patent is a continuation of Provisional Patent: No. 60/202,498 filed May 5, 2000.

### FIELD OF INVENTION

The present invention relates to stone cutting and more particularly it is a stone cutter using a hydraulically driven wedge in order break stones.

### PRIOR ART

In the art of stone cutting most stones are cut by hand and it is a long and tedious process.

It involves the use of laborious techniques with hand held metal tools, table mounted saws and scoring devices.

### GENERAL DISCUSSION OF THE INVENTION

The invention is a stone splitter which utilizes a hydraulic arm ending in a point or wedge in order to split stones. The hydraulic arm has a point on one end and the opposite end fits within a hydraulic cylinder which forces the wedge into the stone. A fixed wedge opposite the wedge on the hydraulic arm is provided.

A power supply provides for hydraulic fluid under pressure as with an electric pump or gas pump.

In order to get an adequate result, the hydraulic arm operates within the tolerances of speed and force so as to properly cut the stone. The hardness of the cutting (59-60 being best) blade is between 46 and 67 on the Rockwell scale.

The force is sufficient to break the stone. The invention may operate slowly in order to not shatter the stones requiring a steady break.

As a result of difficulty in making cuts and damage caused by misalignment and bad strike angles there is a great deal of waste not only of time but also of material in the prior art.

Various devices have been developed in order to try to aid stone cutters but none of those have effectively allowed for the cutting of raw stone.

It is therefore an object of the invention to provide a stone cutter which can be easily used and which is very mobile which can be utilized in order to cut stone or brick of various types and having irregular shapes.

These and other objects and advantages of the invention will become better understood hereinafter from a consideration of the specification with reference to the accompanying drawings forming part thereof, and in which like numerals correspond to parts throughout the several views of the invention.

### BRIEF DESCRIPTION OF DRAWINGS

For a further understanding of the nature and objects of the present invention, reference should be made to the following detailed description taken in conj unction with the accompanying drawings in which like parts are given like reference numerals and wherein:

FIG. 1 shows a perspective view of the preferred embodiment of the cutter.

FIG. 2 shows a side view of alternate embodiment the cutter.

FIG. 3 shows a side view of an alternate embodiment with a striking arm and catch basin.

### DETAILED DESCRIPTION OF THE PREFERRED EXEMPLARY EMBODIMENTS

Two separate side views of two separate embodiments are shown in the drawings.

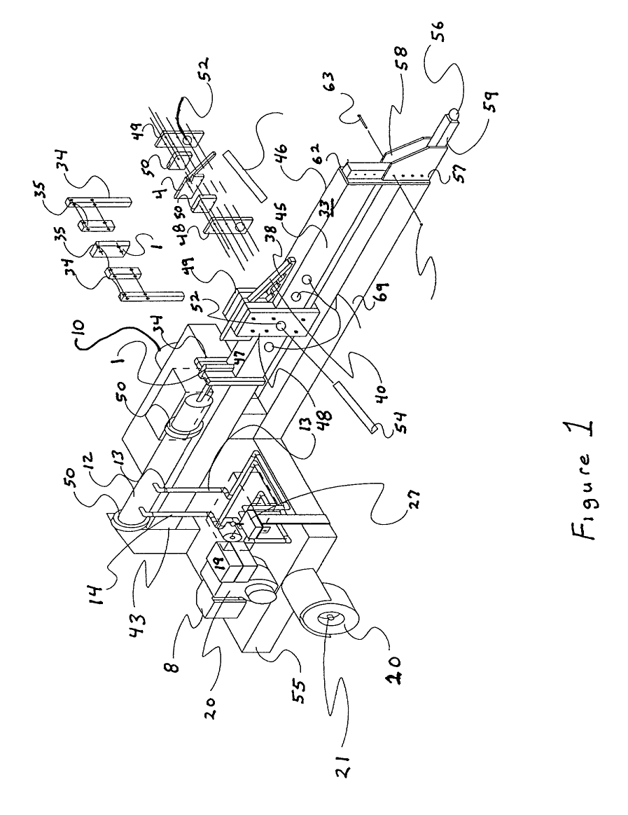

Referring to FIG. 1 the rock cutter for splitting stones has (a) a support means, iron bar 42, having a first end 43, a second end 44, a left side 45 and a right side 46 and a support length between the first end and the second end and a support surface 47 along the support length for supporting a rock to be cut (not shown). A lower

The first blade holding means is defined by a support arm 48 slidably contacting the left side and a support arm 49 slidably contacting the right side of the iron bar 42 so that the position of the first blade 1, held centered by centering spacers 50 is supported slightly above (by the spacers 50) and on either side (by the support arms 48 and 49) of the iron bar 42 as the blade 1 moves along the support length. If necessary, the bottom of the two support arms may be attached for added support. The piston is also supported by two rings 51 so that the piston is also adequately supported.

The first blade 1 has a sharpened edge 31 with a first blade edge length so that it forms a wedge which is driven by the piston into the rock to be split.

The second blade 4 is similarly designed. It is attached to a second blade holding means for holding a blade in a fixed position on the support means along the support length which is similar to the means holding the first blade having centering a support arm 48a slidably contacting the left side and a support arm 49a slidably contacting the right side of the iron bar 42 so that the position of the second blade, held centered by centering spacers 50a is supported slightly above (by the spacers 50a) and on either side (by the support arms 48a and 49a) of the iron bar 42 as the blade is moved to a fixed location along the support length.

The method of fixing the blades to the spacers and support arms is by way of bolting these parts together so that a very stiff arrangement of the blades is accomplished so that the edges of the blades are in the same plane. The second blade 2 has a sharpened edge 32 and a second blade edge length which is preferably the same as the first blade length so provide for better splitting along a similar fault line.

The cutter blade support means supports the first blade so that the first blade length is approximately perpendicular to the support surface.

In the preferred embodiment the first blade holding means comprises a hydraulicly driven piston having a hydraulic cylinder and a piston arm with a blade holding means for holding the first blade so that it is approximately perpendicular to the support surface.

A shock means is also provided in some embodiments for applying a sudden force to the first blade.

The second blade holding means comprises a support arm 48a slidably contacting the left side of the support surface 47 and a support arm 49a slidably contacting the right side of the support surface 47 so that the position of the second blade 4 is supported where held along the support length which is the area of the support surface 47 between the two blades.

The second blade holding means further comprises a fixing means for holding the second blade at a fixed position along the support length. In the preferred embodiment, the fixing means comprises at least one opening 52 defined by each of the support arms 48a and 49a contacting the left side and right side of the support beam 42 and a plurality of corresponding openings 53 defined along the left side and passing through the right side of the support beam 42 and a securing means, hear a bolt 54 fitting through the support arm openings 52 and at least one of the plurality of beam openings 53.

An alternative method of fixing the position of the second blade 4 would be a brake 40 having a first end and a second end with the first end attached to the second blade 4, a plurality of notches 38 defined along the support surface and wherein the second end of the brake is insertable into at least one of the plurality of notches 38. Under either embodiment or the equivalent thereof, the purpose is to allow the support surface length to be adjusted in accordance with the rock to be split without requiring a greater length to piston arm 11 so that the piston arm 11 may move, but still be relatively fixed in position relative to the cutting edge of the second blade 4. To this end, the piston cylinder 12 is fixed in position by two heavy rings 51 which are tightly welded or bolted to the support beam 42 so that the alignment and movement of the piston stays consistent through use to drive the first blade edge and second blade edge together along a common plane. This brake may be incrementally adjustable by having a ring bolt as part of the brake so that the length of the brake is adjustable incrementally. This is usually less necessary since the piston arm position can also be adjusted incrementally.

While in the preferred embodiment, the fixing means comprise a brake or movement of plates along the support beam, the second blade may be supported separately from the first blade. To do this, a receiving bracket defining a bracket opening is attached to the support first end 43 and a rod attached to the second blade support is movably inserted within the bracket opening so that the distance between the blades is controlled by the amount of insertion between the rod and bracket. There is a fixing means, such as a bolt threaded through the bracket, to fix the position of the rod so as to fix the length between the parts. This bolt may be replaced by a piston cylinder and arm so that the distance may be fixed hydraulically, although this embodiment would be for remote or larger applications.

In order to allow the user to move away from the stone as it is cut, there may be a catching means located along the length of the support means and below the support surface for receiving pieces falling from the support surface. In the preferred embodiment, the catching means comprises an angled plate 26 rising on either side of the support surface from below the support surface to form a catch basin so that rocks split fall onto the angled sides.

A beam 69 adds support below the support surface.

By using a catch basin, a shield means located on the first end and fold-able above the support length is possible so that a rock supported on the support surface may be covered to prevent chips of rock from exiting the work area.

To keep the device transportable, it also comprises a supporting frame 55 attached below the support beam for supporting the motor and controls 20 and pump 19 for supplying hydraulic fluid to the hydraulic cylinder 12. To add mobility to the device, it also comprises an axle 21 rotatably connected below the supporting frame 55 and wheels 10 attached to either side of the axle 21.

Where the device is to be hauled, only a single axle is necessary (it may be driven by it's own motor with two sets of wheels or a three wheel arrangement). Where hauled, it has a trailer hitch 56 attached to the second end 44 of the support beam 42 so that the rock splitter may be attached to a corresponding trailer hitch on a vehicle for moving the unit. In the preferred embodiment, the hitch 56 comprises an attachment means for holding the vehicle, such as a joint of a ball and joint arrangement attached to a horizontal arm 62. On either side of the horizontal arm 62 are a left vertical plate 57 and a right vertical plate 58. These plates 57 and 58 may have extensions which fit into grooves formed by a vertical arm 59 which is attached to the second end of the support beam 42 to maintain alignment. A fixing means, such as a bolt 63, may pass through holes 60 in the plates 57 and 58 and through one of a plurality of holes 61 in the vertical arm 59 so that the trailer formed by the beam 42 and frame 55 may be leveled regardless of the height of the hitch.

While the plate and arm arrangement of the preceding paragraph is described as being a part of the trailer, the same arrangement may by way of alternative embodiment, by attached to the portion of the trailer hitch attached to the hauling vehicle.

The rock cutting process follows the process steps wherein:

1. The blades are separated by a distance adequate to allow the stone to be put into place with the stone marked on either side where the cut it to be made as with a chalk line;

2. The blades are then slowly adjusted so that they come together on either side where the cut is to be made;

3. Thereafter the user moves back so that potential flying rock or debris does not hurt the user and activates the slow expansion of the piston rod;

4. Once the stone breaks into two pieces cut thereby and falls in the V the user can remove them for use or reposition them for further cuts.

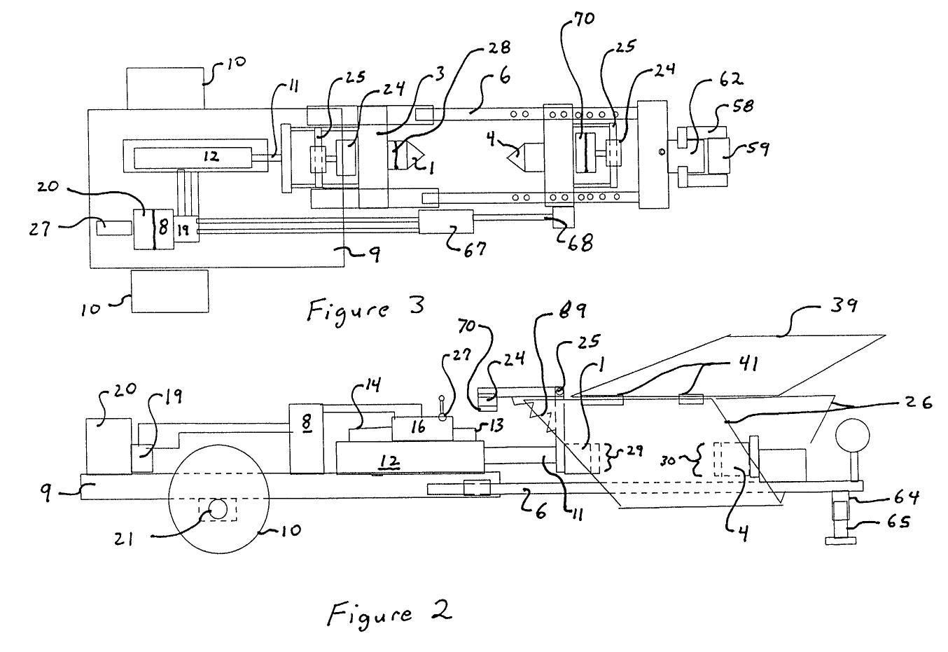

As can be seen by reference to FIG. 2, the beam supporting the nonmoving blade is held on a beam (adjusting arm 6) which fits within fits within a bracket 66 defined by a second beam which (fixed arm 7) the wedge mounting 3 is attached. There is a trailer hitch so that the device may be carried like a trailer and there is at least one foot 67 which travels downward to the ground. The foot 67 may be held at an adjustable height so that the device may be leveled on uneven ground. Here it is leveled by a stand 64 from which a stand extension 65 adjustably extends.

When the device is used the stone to be cut is put in place between the two blades 1 and 4. Each of these wedge shaped blades has a blade that is sufficiently sharp in order to make proper cut on the stone in question.

The valves controlling the piston for pushing the piston arm forward and into the stone are then pressurized. The appropriate pressure is may be variable and the speed of the fluid flow may be variable to accommodate different stones.

This serves to move the blades forward at a sufficient speed so that stone is cut and not shattered. Hammer arrangements are shown in FIGS. 2 and 3 to apply sudden impact where desired, particularly at the center of the wedges 1 and 4 once they are in place. A cam system (not shown) may be used to automatically trigger the hammer 24 when a sufficient amount of pressure placed is on the stone by the two wedge shaped blades 1 and 4. A pressure gauge 28 located where appropriate, here behind the blade 1 may be used to visually determine this also or to automatically trigger this.

As shown on FIG. 2, once the stone is firmly held between the two blades, a striking hammer 24 pivoting on a hammer pivot 25 may be used to deliver a sudden, very fast impact to the stone through one or both of the wedges to split stones requiring that type of blow. This may be assisted with a spring 89 (as shown in FIG. 2) or other force or speed building device. The hammer and wedge holder may be designed as shown in FIG. 2 so that the hammer may strike the middle of the rear of the wedge. FIG. 2 shows a hammer in a raised position. FIG. 3 shows a hammer in a lower position. The hammer may have pad 70 to cushion it.

Before the stone is cut the blades are moved together so that the stone is held fixed between the two. Arms 6 may be in place in order to support the stone between the two blades 1 and 4 in the event that if they cannot be held there manually either because of the size or because the stone is uneven or for safety reasons.

As can be seen in reference to FIG. 1 the cutting surface may be elevated. The purpose for this elevation is to make it easier to work on the cutting surface.

Alternatively you could have a device which would have a variable height so that stone could be cut at different levels.

The blades 1 and 4 are preferably made out of tool steel and have a point which is between 1/32″ and ⅛″ in diameter. The length of the blade up and down is such that it is preferably at least as long as most pieces of rock which will be cut.

It necessary that two blades be on either side of the cut in order that the matrix of the stone is split evenly.

A sharper width of the blade is possible but in most cases not desirable since it would result in undue wear and tear on the blades. It is possible that one of the blades may be less sharp and still obtain the appropriate cutting features.

The invention also comprises a V-shaped rock catching member, angled plate 26, on either side of the stone. This particular angled plate 26 would be larger than the width of a typical stone which would be cut utilizing this invention and would have the primary purpose, not of holding the stone, but of catching the two pieces that are cut with after the cut takes place. It could also be used to hold the stone lightly, although it is felt that this would not work as well. In FIG. 2, it is shown that a shield 39 on hinges 41 can be attached at the top of the one of angled plates 26 to prevent rock splinters from injuring the user.

Any holding mechanism preferably would not compress the stones since that might result in an uneven cut but would instead hold it loosely in place.

The hydraulics are slow speed hydraulics since high speed hydraulics would tend to shatter the stone and a slow steady pressure on blades of the type described herein yields a good cut. A control 27 is provided to drive the piston.

In use the invention is practiced in the following process steps:

1. The blades are separated by a distance adequate to allow the stone to be put into place with the stone marked on either side where the cut it to be made as with a chalk line;

2. The blades are then slowly adjusted so that they come together on either side where the cut is to be made;

3. Thereafter the user moves back so that potential flying rock or debris does not hurt the user and activates the slow expansion of the piston rod;

4. Once the stone breaks into two pieces cut thereby and falls in the V the user can remove them for use or reposition them for further cuts.

As can best be seen by reference to FIG. 1 the invention comprises a moving blade 1 which is aligned with a still blade 4 utilizing outside aligning holes 2 and inside aligning holes 5.

There are two blades 1 and 4 which are removably attached to the blade mountings 3. The blade is removably attached to a blade mounting 3 in order to allow it to be replaced or sharpened.

The moving blade 1 is on an adjusting arm six which in turn is fixed relative to a fixed arm 7 by way of the aligning holes 2 and 5. The aligning holes may be replaced with any other mechanism allowing the distance to be varied to match the size of the stone to be cut. One example would be to have a hydraulicly operated arm to fit the two together and this fitting could be done automatically for pressure on both of the arms serve to cut off the hydraulic movement bringing the stone together.

One or both of the arms may be supplemented by a adjusting straps or locking sides to hold the stone in place and shown in FIG. 3.

An electric or gas motor 20 powers a two stage pump 19 which supplies hydraulic fluid from reservoir 8 under pressure to hydraulic valve shown at the control in FIG. 2. In order to add some mobility of the system the fixed arm is preferably mounted on a frame 9 which in turn rests on axles 21 which axles 21 are supported by wheels 10.

The valve 16 provides power to a piston cylinder 12 which drives a piston arm 1 1.

On the end of the piston arm 11 is the wedge mounting 3 which supports the moving blade 1.

An alternate cylinder 67 driving alternate arm 68 may control the position of the fixed second wedge 4.

There is a line from the inlet to cylinder extension 14. There is also a line from valve 16 to the outlet to cylinder return. The inlet provided from the hydraulic reservoir 8 and a fluid return 17 to the hydraulic reservoir.

Because many varying and different embodiments may be made within the scope of the inventive concept herein taught and because many modifications may be made in the embodiment(s) herein detailed in accordance with the descriptive requirements of the law, it is to be understood that the details herein are to be interpreted as illustrative and not in a limiting sense.

1. A rock cutter for splitting stones comprising: (a) a support means having a first end, a second end, a left side and a right side and a support length between the first end and the second end and a support surface along the support length for supporting a rock to be cut;
(b) a first blade holding means attached to the support means for holding a blade and extending the blade along the support length;
(c) a first blade having a sharpened edge with a first blade edge length attached to the first blade holding means,
(d) a second blade holding means for holding a blade in a fixed position on the support means along the support length,
(e) a second blade having a sharpened edge and a second blade edge length.

2. The cutter of claim 1 wherein the support means wherein the first blade holding means supports the first blade so that the first blade length is approximately perpendicular to the support surface.

3. The cutter of claim 1 wherein the first blade holding means comprises a hydraulicly driven piston having a hydraulic cylinder and a piston arm with a blade holding means for holding the first blade so that it is approximately perpendicular to the support surface.

4. The invention of claim 3 further comprising a shock means for applying a sudden force to the first blade.

5. The invention of claim 3 wherein the first blade holding means further comprises a support arm slidably contacting the left side and a support arm slidably contacting the right side so that the position of the first blade is supported as the blade moves along the support length.

6. The invention of claim 5 wherein the second blade holding means comprises a support arm slidably contacting the left side and a support arm slidably contacting the right side so that the position of the second blade is supported where held along the support length.

7. The invention of claim 6 wherein the second blade holding means further comprises a fixing means for holding the second blade at a fixed position along the support length.

8. The invention of claim 7 wherein the fixing means further comprises an opening defined by the support arm contacting the left side adjacent to the left side, a plurality of corresponding openings defined by the left side and a securing means fitting through the support arm opening and at least one of the plurality of left side openings.

9. The invention of claim 8 wherein the fixing means further comprises an opening defined by the support arm contacting the right side adjacent to the right side, a plurality of corresponding openings defined by the right side and a securing means fitting through the support arm opening and at least one of the plurality of right side openings.

10. The invention of claim 7 wherein the fixing means further comprises a brake having a first end and a second end with the first end attached to the second blade, a plurality of openings defined along the support surface and wherein the second end of the brake is insertable into at least one of the plurality of openings.

11. The invention of claim 1 wherein the support means first end is movably attached to the support means second end and wherein the first blade holding means is attached to the first end and the second blade holding means is attached to the second end and wherein the support means further comprises a fixing means for controlling the movement of the first end from the second end so that the distance between the first blade and second blade may be adjusted.

12. The invention of claim 11 wherein the fixing means comprises a receiving bracket defining an opening on the first end and a rod attached to the second end movably inserted within the opening of the receiving bracket and a fixing means to fix the degree of insertion of the rod so as to fix the length of the support means.

13. The invention of claim 1 further comprising a catching means located along the length of the support means and below the support surface for receiving pieces falling from the support surface.

14. The invention of claim 13 wherein the catching means comprises an angled plate rising on either side of the support surface from below the support surface so that rocks split fall onto the angled sides.

15. The invention of claim 1 further comprising a shield means located on the first end and foldable above the support length so that a rock supported on the support surface may be covered to prevent chips of rock from exiting the work area.

16. The invention of claim 3 further comprising a supporting plate attached to the support means for supporting a motor for supplying hydraulic fluid to the hydraulic cylinder.

17. The invention of claim 16 further comprising an axle rotatably connected to the supporting plate below the support means and a plurality of wheels attached to the axle and wherein the invention further comprises a trailer hitch attached to the supporting plate so that the rock splitter may be attached to a trailer hitch for movement.

18. A rock cutting process following process steps:
1. The blades are separated by a distance adequate to allow the stone to be put into place with the stone marked on either side where the cut it to be made as with a chalk line;
2. The blades are then slowly adjusted so that they come together on either side where the cut is to be made;
3. Thereafter the user moves back so that potential flying rock or debris does not hurt the user and activates the slow expansion of the piston rod;
4. Once the stone breaks into two pieces cut thereby and falls in the V the user can remove them for use or reposition them for further cuts.

19. A hitch for holding a trailer to a vehicle comprising:
A) an attachment means for holding the vehicle, such as a joint of a ball and joint arrangement attached to a vertical arm;
B) an alignment walls on either side of the vertical arm;
C) a fixing means for fixing the location of the vertical arm to the alignment walls.

20. The invention of claim 19 wherein the vertical arm comprises at least one arm opening and wherein at least one of the alignment walls defines at least wall one opening and wherein the fixing means comprises a rod means insertable through the at least one arm opening and at least one wall opening.
